(19) United States
(12) Patent Application Publication
(10) Pub. No.: US 2023/0173627 A1
(43) Pub. Date: Jun. 8, 2023

(54) TOOL CHANGING DEVICE, MACHINE TOOL AND METHOD FOR CHANGING A TOOL

(71) Applicant: CHIRON Group SE, Tuttlingen (DE)

(72) Inventors: Matthias EFINGER, Aixheim (DE); Sebastian HUBER, Wurmlingen (DE)

(21) Appl. No.: 18/072,049

(22) Filed: Nov. 30, 2022

(30) Foreign Application Priority Data
Dec. 2, 2021 (DE) 10 2021 131 810.6

(51) Int. Cl. B23Q 3/157; B23Q 3/155

(52) U.S. Cl. CPC B23Q 3/15713; B23Q 3/15503

(57) ABSTRACT

A tool changing device for a machine tool comprises a tool magazine, a transfer device and a linear drive for the tool magazine. The tool magazine comprises a magazine axis, wherein the tool magazine is rotatable about the magazine axis by a rotary drive, and a plurality of holding locations for tools that have a support shaft and a receiving groove. At least some of the holding locations are arranged offset relative to one another along the magazine axis, and at least some of the holding locations are arranged offset relative to one another about the magazine axis. The holding locations are configured to hold the tools at the receiving groove. The transfer device comprises a transfer carriage, wherein the transfer device is movable between a first transfer position in relation to the tool magazine and a second transfer position to transfer tools between the tool magazine and a tool holder of the machine tool. The linear drive is configured to move the tool magazine along the magazine axis relative to the transfer device to provide, together with the rotary drive, a selected holding location in the first transfer position.

### CROSS-REFERENCE TO RELATED APPLICATIONS

This application claims priority to German patent application 10 2021 131 810.6, filed on Dec. 2, 2021. The entire content of this priority application is incorporated herein by reference.

### BACKGROUND

The present disclosure relates to a tool changing device for a machine tool. Furthermore, the present disclosure relates to a machine tool that is provided with such a tool changing device and to a method for changing a tool.

U.S. Pat. No. 4,920,631 A discloses a tool magazine for machine tools, which is mounted on a column, can be rotated about the column and can be moved vertically along the column. Tools are accommodated gapless in radial orientation along the circumference of the tool magazine, so that direct access for a tool changer is not possible. A shifting unit is installed inside the tool magazine, which moves requested tools out of the tool magazine, so that a transfer to a separate tool changer is possible. This means that further handling technology must be installed inside the tool machine in order to implement the shifting unit.

EP 2 177 310 A2 discloses a machining center having a tool magazine of columnar design that is integrated in its working space, wherein the tool magazine comprises a plurality of receptacles for tools that are oriented orthogonally to the longitudinal extension of the column and radially to a center axis of the column. The machining center includes a tool spindle that is pivotable between a substantially vertical orientation and a substantially horizontal orientation, such that the tool spindle can grip and clamp tools that are placed with their machining side in the tool magazine at their shaft side. The tool magazine is movable along a linear axis towards the tool spindle. The tool spindle is movable along a linear axis that extends parallel to the center axis of the column.

U.S. Pat. No. 6,228,006 B1 discloses a machining center with a tool spindle and a rotary table, wherein the rotary table has one or more locations for receiving workpieces, and wherein the rotary table has at least one location for a disc magazine with discs that are arranged one above the other. The discs form a plurality of levels of the disc magazine. Tools are arranged on the levels of the disk magazine in a lying orientation, with a respective tool shaft being oriented radially outward. The tool spindle can be moved vertically towards the levels of the disk magazine, wherein the tool spindle has a concentric orientation with respect to a tool shaft of a tool to be changed.

US 2017/0282316 A1 discloses a disc magazine for tools of a machine tool that is arranged on a stand, wherein the disc magazine has a plurality of discs that are arranged one above the other and provided with receptacles for tools in a vertical orientation. Furthermore, at least one tool changer having a double gripper is provided, which is movable parallel and substantially radially to a longitudinal axis of the disk magazine, and which grips tools at a gripper groove adjacent to a support cone. The tools can be inserted into radially outwardly open seats of a disc and clamped there. The tool changer can change the tools into a tool receptacle of a machining spindle.

U.S. Pat. No. 7,232,406 B2 discloses a machine tool having a tool changing device, wherein the tool changing device is coupled laterally to a working space and comprises a circulating chain magazine having a vertical orientation. For the tool change, a shuttle is provided, which moves tools between the magazine and a change position, wherein the tool in the change position projects only with its shaft through a change opening into the working space and can be picked up by a machining spindle. Two tools are changed by a rotatable double gripper that is positioned outside the working space.

The integration of automated devices for tool changing is often subject to a conflict of objectives. On the one hand, the goal is to achieve the shortest possible tool change time in order to minimize chip-to-chip times. On the other hand, tool magazines with a large capacity to hold a large number of tools are often aimed for. Another challenge is the separation between a working space of the machine tool and the tool magazine. Here, the goal is to minimize contamination and the like outside the working space.

In view of this, it is an object of the present disclosure to present a tool changing device and a machine tool that is provided with a tool changing device, wherein on the one hand a large number of tools can be kept available and on the other hand a sufficiently fast tool change is possible.

It is a further object of the present disclosure to present a tool changing device that has a compact overall design and preferably a small footprint.

It is a further object of the present disclosure to present a tool changing device, wherein a tool change requires only little interaction with the working space during tool change.

It is a further object of the present disclosure to present a machine tool that is provided with a tool changing device.

It is a further object of the present disclosure to present a corresponding method for changing a tool.

### SUMMARY

According to a first aspect, these and other objects are achieved by a tool changing device for a machine tool, comprising:

a tool magazine comprising:
a magazine axis, wherein the tool magazine is rotatable about the magazine axis by a rotary drive, and
a plurality of holding locations for tools that have a support shaft and a receiving groove,

wherein at least some of the holding locations are arranged offset relative to one another along the magazine axis,

wherein at least some of the holding locations are arranged offset relative to one another about the magazine axis, and

wherein the holding locations are configured to hold the tools at the receiving groove,

a transfer device comprising a transfer carriage,

wherein the transfer device is movable between a first transfer position in relation to the tool magazine and a second transfer position to transfer tools between the tool magazine and a tool holder of the machine tool, and

a linear drive for the tool magazine that is configured to move the tool magazine along the magazine axis relative to the transfer device to provide, together with the rotary drive, a selected holding location in the first transfer position.

According to another aspect, the above and other objects are achieved by a machine tool, comprising:

a frame,

at least one workpiece holder for receiving a workpiece,

at least one tool holder for receiving a tool, and

a tool changing device, comprising:
a tool magazine comprising:
   a magazine axis, wherein the tool magazine is rotatable about the magazine axis by a rotary drive, and
   a plurality of holding locations for tools that have a support shaft and a receiving groove,
wherein at least some of the holding locations are arranged offset relative to one another along the magazine axis,
wherein at least some of the holding locations are arranged offset relative to one another about the magazine axis, and
wherein the holding locations are configured to hold the tools at the receiving groove,
a transfer device comprising a transfer carriage,

wherein the transfer device is movable between a first transfer position in relation to the tool magazine and a second transfer position in relation to a tool holder of the machine tool to transfer tools between the tool magazine and the tool holder, and
a linear drive for the tool magazine that is configured to move the tool magazine along the magazine axis relative to the transfer device to provide, together with the rotary drive, a selected holding location in the first transfer position,

wherein the tool holder is movable relative to the frame to the second transfer position for a tool change.

According to another aspect, the above and other objects are achieved by a method of changing a tool at a machine tool, comprising the following steps:

providing a tool magazine having a magazine axis that is rotatable by a rotary drive about the magazine axis and movable by a linear drive along the magazine axis,

wherein the tool magazine has a plurality of holding locations for tools that have a support shaft and a receiving groove,

wherein at least some of the holding locations are arranged offset relative to one another along the magazine axis,

wherein at least some of the holding locations are arranged offset relative to one another about the magazine axis, and

wherein the holding locations are configured to hold the tools at the receiving groove,

providing a transfer device comprising a transfer carriage,

wherein the transfer device is movable between a first transfer position in relation to the tool magazine and a second transfer position in relation to a tool holder of the machine tool to transfer tools between the tool magazine and the tool holder,

moving the tool magazine by the linear drive and the rotary drive to provide a selected holding location for a tool in the first transfer position, and

transferring a tool between the first transfer position and the second transfer position,

wherein in the first transfer position, the tool is directly transferred between the tool magazine and the transfer device, and

wherein in the second transfer position, the tool is transferred between the transfer device and the tool holder.

According to another aspect, the above and other objects are achieved by a tool changing device for a machine tool, comprising:

a tool magazine, which can be rotated about a magazine axis by a rotary drive and has a plurality of holding locations for tools, at least some of which are arranged offset relative to one another along the magazine axis, and at least some of which are arranged offset relative to one another about the magazine axis, the tools having a support shaft and a receiving groove,

a transfer device comprising a transfer carriage, which is movable between a first transfer position in relation to the tool magazine and a second transfer position for transferring tools between the tool magazine and a tool holder of the machine tool, and

a linear drive for the tool magazine, which moves the tool magazine along the magazine axis relative to the transfer device in order to provide, together with the rotary drive, a selected holding location in the first transfer position, wherein the holding locations are configured to hold the tools at their receiving groove.

The tool changing device can also be referred to as a tool storage and changing device. The tool magazine is used to provide a plurality of holding locations for tools. The tool magazine is movable in at least two degrees of freedom of movement. First, the tool magazine can be rotated via the rotary drive. Furthermore, a linear drive is provided for moving the tool magazine along its magazine axis.

In this way, the transfer device can be simple in design. Ideally, it is not necessary to provide a drive for moving the transfer device along the magazine axis. Furthermore, this design allows for a relatively small interface (opening) to the working space for the tool change. In an exemplary embodiment, the transfer carriage is movable linearly along a horizontal axis that is oriented orthogonal with respect to the magazine axis.

The tool magazine is not arranged as a chain magazine, at least in exemplary embodiments. In exemplary embodiments, the tool magazine is designed to be (internally) inherently rigid, with the tool magazine as a whole being designed approximately columnar or tower-like.

According to an exemplary embodiment, the tool magazine is a columnar or tower-shaped magazine with a vertically oriented magazine axis. In such a case, the linear drive for the tool magazine is a lifting drive with a vertical direction of travel.

By way of example, the tool holder is a component of a tool spindle. According to this embodiment, a tool seated in the tool holder can be driven, for instance rotated, by the tool spindle. However, the tool holder can also be designed to receive non-rotationally driven tools, exemplarily for receiving turning tools and the like.

According to another exemplary embodiment, the tool magazine is arranged on a lifting bracket, which is movable, for example, via a plurality of sliders on one or more linear guides. For example, the linear guides are designed as vertical guides so that the tool magazine is vertically movable.

If the tool magazine can be driven in a first direction and a second direction, for instance rotatably and linearly movable, installation space that is not otherwise used can be used for the movement of the tool magazine. In this way, the machine tool can be designed to be compact overall and with a small footprint. This comes into play, for example, when the tool magazine is vertically movable via a lifting drive. Then, a space above the tool magazine can be used when the tool magazine is moved vertically upwards from a lower position.

In an exemplary embodiment, the linear drive is arranged at least partially within the tool magazine. This relates, for example, to a center of the columnar tool magazine. In the center, for example, a spindle of a screw drive or ball screw drive is arranged, which can be rotationally driven by the rotary drive. In this way, the tool magazine is accessible at its circumference. The interior space in the center of the tool magazine, which is otherwise unusable for holding tools, can be used for the linear drive. This results in a compact design.

In an exemplary embodiment, the first transfer position is outside the working space, with the second transfer position being inside the working space. In the first transfer position, for example, the transfer carriage is positioned completely outside the working space. In the second transfer position, for example, the transfer carriage projects at least partially into the working space. When the transfer carriage is positioned outside the working space, an interface and/or access to the working space can be closed.

In an exemplary embodiment, the transfer device allows direct transfer of tools between the tool magazine and the tool holder. In other words, the transfer device takes tools directly from the tool magazine and delivers them directly to the tool holder, and vice versa. Thus, no further handling units are provided between the tool magazine and the transfer device. Similarly, no further handling units are provided between the transfer device and the tool holder, at least in exemplary embodiments.

According to another aspect, the above and other objects are achieved by a method of changing a tool, the method comprising the following steps:

providing a columnar tool magazine, which is rotatable about a magazine axis and movable along the magazine axis, with a plurality of holding locations for tools, at least some of which are arranged offset relative to one another along the magazine axis, and at least some of which are arranged offset relative to one another about the magazine axis,

providing a transfer device having a transfer carriage, which is movable between a first transfer position in relation to the tool magazine and a second transfer position in order to transfer tools between the tool magazine and a tool holder of the machine tool, and which comprises, for instance, a double gripper for a tool change with the tool holder and an offset slide with a transfer receptacle for a tool change with the tool magazine,

moving the tool magazine to provide a holding location for a tool in the first transfer position, and

transferring a tool between the first transfer position and the second transfer position,

wherein in the first transfer position, the transfer takes place directly between the tool magazine and the transfer device, for instance using the offset slide, and

wherein in the second transfer position, the transfer takes place directly between the transfer device and the tool holder, for instance using the double gripper.

The method according to the present disclosure can be configured and detailed analogously to the tool changing device according to the present disclosure. The tool changing device according to the present disclosure can be configured and detailed analogously to the method according to the present disclosure. It is understood that the method can be used analogously for changing a tool from a tool holder of the machine tool for storage in the tool magazine. The sequence of steps is adapted accordingly. If a double gripper is used, a used tool can be replaced by an unused tool in the second transfer position.

According to another exemplary embodiment of the device or method, the transfer device is moved between the first transfer position and the second transfer position along a transfer axis, which is for instance oriented orthogonally to the magazine axis and has a frame-fixed guide, along which the transfer carriage of the transfer device is movable.

Thus, when the tool magazine is movable along the magazine axis by the linear drive, tools can be provided at different levels of the tool magazine. This does not require movement of the transfer device along the magazine axis, at least in exemplary embodiments. In this way, the guide of the transfer device can be fixedly arranged at a frame of the machine tool or the tool changing device.

In other words, according to an exemplary embodiment, only a channel-like tool transfer space with a limited cross-section is provided for the tool change for the transfer device, which extends between the first transfer position and the second transfer position. In other words, even with a large (high) tool magazine, the transfer device requires only a limited installation space in the immediate vicinity of the working space.

In other words, for the movement of the transfer carriage along the transfer axis, the transfer device uses a guide, which is immovable with respect to the frame in directions transverse to the guide. This applies at least to exemplary embodiments. It is understood that the transfer device may have further (internal) degrees of freedom of movement in the transfer carriage in order to support the tool change.

According to another exemplary embodiment of the device or method, the first transfer position is fixed, for instance with respect to a frame of the machine tool or the tool magazine. In other words, the tool magazine can be driven in such a way that a requested level (linear position) and a defined location (rotational position) on this level are available in the first transfer position. The first transfer position can be approached from the point of view of the tool magazine by the rotary drive and the linear drive. In this way, requested holding locations can be moved to the first transfer position

The frame is, for example, a machine frame or machine bed of the machine tool. However, it can also be a magazine frame, i.e., a frame of the tool changing device.

In an exemplary embodiment, the second transfer position is also fixed, for instance with respect to the frame. In this way, the opening to the working space, through which the tool is changed between the transfer device and the tool holder, can be made sufficiently small.

According to a further exemplary embodiment of the device or method, a direct transfer of the tools between the transfer device and the holding locations of the tool magazine is enabled. Thus, no complex active handling technology is required at the tool magazine itself in order to release a tool or to take it over from the transfer device. This simplifies the setup of the tool magazine and shortens the provisioning times with regard to the selected holding location. By way of example, a tool can be pulled out of a holding location laterally (with respect to a longitudinal axis of the tool) or inserted into the holding location and set down there. The actual support shaft is not necessarily occupied by the placement in the tool magazine.

According to another exemplary embodiment of the device or method, the tool magazine comprises two or more segments that are distributed around the magazine axis with holding locations that are offset from one another in series along the magazine axis. In an exemplary embodiment, the holding locations are open laterally outwardly so that tools can be removed laterally (orthogonally to the magazine axis) outwardly. In an exemplary embodiment, the segments are shaped similarly to blades that are arranged around the magazine axis. In this embodiment, the segments each have a longitudinal extent that is substantially parallel to the magazine axis. In an exemplary embodiment, the tool magazine is formed similar to a standing paddle wheel.

According to a further exemplary embodiment of the device or method, the segments comprise holding locations in the form of outwardly open recesses, which are adapted to receiving grooves of the tools. Tools can thus be seated and guided with their receiving grooves in the tool magazine. By way of example, the receiving grooves are also referred to as gripper grooves. With this design, it should be noted that the receiving grooves are blocked when the tools are seated in the tool magazine, so that no handling element can engage there to remove the tools. However, the design of the holding locations basically allows tools to be guided laterally out of the segments. Such a movement is oriented orthogonally to the magazine axis, for example.

The holding locations are arranged or formed in the segments. The tools have, for example, a support shaft, for example in the form of a hollow taper shank (HSK), steep taper shank or the like. The support shaft is adjoined, for example, by a receiving groove. In the received state in the holding locations of the segments, the tools are each oriented with their longitudinal axis orthogonal to the holding locations in the segments. The longitudinal axis of the tools is oriented horizontally and orthogonally to the magazine axis, for example.

The tools are force-locked and/or positively secured in the holding locations, for example by a retaining spring. In this way, no complex control technology or drive technology is required. The tool magazine can be of simple design. When the force of the retaining spring is overcome by the transfer device, tools can be inserted into or removed from the holding locations, for instance laterally (orthogonally to the magazine axis).

For example, in a loaded state at least one tool is received and secured with its receiving groove in a holding location, for instance force-locked and/or positively secured.

According to a further exemplary embodiment of the device or method, the transfer device has a transfer receptacle, which is for instance configured to engage around a support shaft of a tool. For example, the transfer receptacle is quiver-like in design. The transfer receptacle is adapted to the support shaft of the tool.

In other words, the transfer receptacle does not use the same contour of the tool as the holding location. This allows a direct change of the tool between the transfer device with the transfer receptacle and the tool magazine with the holding location.

For example, a transfer receptacle for a tool is provided on the transfer device, for instance on the transfer carriage, which is designed similarly to the tool holder of a tool spindle and/or at least partially imitates it. The transfer receptacle can be a receptacle that is adapted to a tapered shank (HSK or the like).

In other words, the transfer receptacle uses sections of the tool, in which it is usually held on the tool holder. The tool magazine, on the other hand, uses other sections, such as tool receiving grooves, which are intended for handling.

The transfer device can therefore remove a tool from its seat in the tool magazine using the transfer receptacle. Once the tool has been removed in this way and held on the transfer receptacle, it can be transferred to the tool holder on the machine tool side, using further elements of the transfer device, if necessary.

In an exemplary embodiment, the transfer receptacle is oriented parallel to the transfer axis so that the longitudinal axis of a received tool is also oriented parallel to the transfer axis. In this orientation, the tool can be removed from the tool magazine or placed in a holding location in the tool magazine. In an exemplary embodiment, this orientation is also maintained for transfer to the tool holder and for removal of the tool from the tool holder.

According to another exemplary embodiment of the device or method, an offset axis is provided on the transfer carriage of the transfer device, which offset axis moves the transfer receptacle between a retracted position and an extended position. In this way, the transfer receptacle can be moved as a component of the transfer carriage along the offset axis, which is inclined relative to the transfer axis. In this way, sufficient stroke is provided transverse to the transfer axis so that in the first transfer position the transfer receptacle can be brought into concentric alignment relative to a selected holding location, for example.

The offset axis is, for example, inclined with respect to the transfer axis, for instance oriented orthogonally thereto. The engagement and disengagement between the support shaft and the transfer receptacle is effected by an adapted travel movement of the transfer carriage along the transfer axis.

In the extended position, the transfer receptacle can couple to a tool that is provided in the tool magazine in the first transfer position. The offset axis can then move the transfer receptacle from the extended position to the retracted position. This allows the tool to move laterally out of its holding location in the segment of the tool magazine.

When the transfer receptacle carries a tool to be deposited in the tool magazine, the tool is moved laterally into a holding location that is provided by the tool magazine in the first transfer position when the offset axis moves from the retracted position to the extended position. The transfer receptacle can then be decoupled from the deposited tool along the transfer axis (orthogonal to the offset direction).

The coupling movement and/or the uncoupling movement can be provided by the (global) transfer axis of the transfer carriage. In this way, the transfer receptacle can engage around the support shaft of the tool or disengage therefrom.

According to another exemplary embodiment of the device or method, the transfer receptacle has resilient locking elements to secure a received tool. In this way, no complex control with an actuator or the like is required to secure the tool to the transfer receptacle. Instead, a spring force must be overcome to couple the tool to or release it from the transfer receptacle, respectively.

According to another exemplary embodiment of the device or method, at least some of the holding locations of the tool magazine are coupled to a retaining spring that secures a received tool in the holding location with a locking element, wherein the transfer device comprises an offset slide that supports the transfer receptacle and that is configured to deflect the retaining spring to deposit or release a tool in or from the holding location.

In other words, the offset slider that comprises the transfer receptacle may lock or unlock a holding location for a tool in order to safely deposit a tool there or to transfer it from the holding location. According to an exemplary embodiment, the offset slide has displacement pieces that can contact and actuate contact pieces of the retaining spring of the holding locations both when the offset slide moves along the offset axis and when the offset slide moves along the transfer axis. This can be achieved, for example, by a suitable inclination of contacting flanks of the contact pieces and the displacement pieces, so that, for example, a ramp-like movement path results for the movement along the offset axis, which eventually deflects the contact pieces and thus the retaining spring in the transfer direction.

According to another exemplary embodiment of the device or method, the transfer device has a double gripper arranged on the transfer carriage, which is for instance pivotable about a pivot axis. In this way, the transfer device with the double gripper can provide a location for a tool to be replaced and a location for a tool to be changed in. Tool change times can be reduced. With little time required, a tool sitting in the tool holder can be removed and replaced by a new tool. Further travel movements of the transfer device do not directly affect the chip-to-chip times.

For example, the rotary axis of the double gripper is oriented parallel to the transfer axis. Thus, the offset axis is inclined with respect to the rotation axis, for instance oriented orthogonally with respect to the rotation axis.

The double gripper is configured, for example, to grip a tool at a receiving groove. For example, the double gripper and the holding locations of the segments of the tool magazine use the same pick-up contour or receiving groove of the tool and/or its support shaft. In this way, a direct transfer between the tool magazine and the double gripper is made more difficult. Therefore, at least in exemplary embodiments, the transfer receptacle is interposed so that the tool is transferred from the tool magazine to the transfer receptacle and can then be removed from the transfer receptacle by the double gripper. The double gripper can in turn be used to change the tool into the tool holder. By way of example, the tool holder is the tool receptacle of a tool spindle.

Immediately prior to the changeover, the double gripper can remove with its free location a tool that is previously held in the tool holder of the tool spindle. This previously used tool is transferred from the tool holder to the double gripper, from the latter to the transfer receptacle and from the latter finally to a free holding location in the magazine. During a change between the magazine and the tool holder, a tool is thus positioned at least temporarily at the transfer receptacle and temporarily at the double gripper.

According to a further exemplary embodiment of the device or method, at the transfer carriage there is further provided a lifting axis, which is associated with at least one of the double gripper and the transfer receptacle, in order to enable a transfer of tools between the double gripper and the transfer receptacle. Both the double gripper and the transfer receptacle are arranged at the transfer carriage, therefore a movement of the transfer carriage along the transfer axis cannot cause a relative movement between the double gripper and the transfer receptacle along the transfer axis. The stroke axis is oriented parallel to the transfer axis, at least in exemplary embodiments. Consequently, if the transfer axis is horizontally oriented, the stroke axis is also horizontally oriented.

The double gripper is designed, for example, to grip tools at a receiving groove. According to this embodiment, the double gripper can engage laterally with a tool. The transfer receptacle is configured, for example, to hold tools on its support shaft. According to this embodiment, the transfer receptacle can engage the tool in the longitudinal direction of the tool. In such a constellation, an additional stroke axis permits the change between the transfer receptacle and the double gripper. The stroke axis causes, for example, a retracting and/or extending movement between the support shaft and the transfer receptacle.

According to another exemplary embodiment of the device or method, the stroke axis is associated with the double gripper, wherein the stroke axis coincides with the pivot axis of the double gripper. This can result in a lifting movement within the transfer device, wherein elements of the transfer device that are arranged on the transfer carriage can be moved relative to one another, for instance parallel to the transfer axis.

According to a further exemplary embodiment of the device or method, the transfer carriage actuates a door closing the working space during the travel movement between the first transfer position and the second transfer position, wherein the transfer carriage particularly projects into the working space, at least temporarily. This is possible without an additional drive and consequently without a corresponding control system. In an exemplary embodiment, the transfer carriage moves from a position outside the working space at least temporarily into a position, in which at least a section of the transfer carriage projects into the working space. During this movement, the door is opened.

The door is, for example, a pivotable flap or a linearly movable door that is movable by the transfer carriage. For example, the transfer carriage has an extension arm with a sliding piece to actuate the door. The door is designed, for example, so that closing can take place automatically assisted by gravity when the transfer carriage is positioned completely outside the working space. This may have the advantage that the opening to the working space is closed automatically when the transfer carriage is moved from the second transfer position to the first transfer position.

According to a further exemplary embodiment of the device or the method, a scanner, for instance a scanner that is fixed to the frame, is assigned to the tool magazine for tool identification, wherein the tool magazine is moved along the magazine axis and rotated about the magazine axis in order to bring a selected holding location into a detection range of the scanner. Since the tool magazine is movable along at least two axes, all tool locations in the tool magazine can also be detected by a scanner with a limited detection range. The scanner is configured, for example, for optical detection (barcode), detection of electromagnetic signals (RFID) or in a similar manner.

According to another exemplary embodiment of the device or method, the tool magazine has an access door, through which a plurality of holding locations, for instance holding locations that are offset from one another along the magazine axis, are accessible from the outside. In this way, a block setup is made possible, and the tool magazine can be loaded or unloaded through the access door. In case the extension of the tool magazine along the magazine axis is larger than an opening released by the access door, the tool magazine can be moved by the linear drive. Furthermore, the rotary drive can be used to provide desired holding locations in the area of the access door.

According to another aspect, the above and other objects are achieved by a machine tool comprising a frame, at least one workpiece holder for receiving a workpiece, at least one tool holder for receiving a tool, and a tool changing device according to at least one of the embodiments described herein, wherein the tool holder is movable relative to the frame into the second transfer position for a tool change.

The transfer device of the tool changing device can exchange tools directly with the tool holder. Only a relatively small access opening to the working space is required for tool changing, even with a large tool magazine with considerable capacity.

According to an exemplary embodiment of the machine tool, the tool holder is pivotable to bring the tool holder in the second transfer position into a transfer orientation for tool change, wherein the transfer orientation of the tool holder for instance comprises an orientation parallel to the transfer axis. This relates, for example, to a change between a vertical orientation and a horizontal orientation. In general, such a degree of freedom of movement can also be used during machining.

According to another exemplary embodiment of the machine tool, the tool holder is part of a pivotable tool spindle, wherein the tool holder is configured for receiving a support shaft of the tool, and wherein the support shaft of a received tool is placed concentrically in the tool holder. The pivotable tool spindle can be moved to an orientation that is favorable for tool change, for example a horizontal orientation.

According to a further exemplary embodiment of the machine tool, the workpiece holder is assigned to a workpiece spindle, which is configured to rotate workpieces about an axis oriented for instance parallel to the transfer axis, wherein the tool holder is movable in at least three axes relative to the workpiece holder. This allows a favorable arrangement of the tool magazine as well as the transfer device. A machine tool with tool spindle and workpiece spindle allows various turning operations, milling operations and the like, wherein a great freedom of design is given.

In an exemplary embodiment of the machine tool, the tool spindle is linearly movable relative to the frame in three axes and pivotable in one axis. The pivot axis enables the transfer orientation of the tool holder. The linear axes allow the second transfer position to be approached for the tool change.

According to another exemplary embodiment, the tool magazine is arranged adjacent to the workpiece spindle outside the working space, wherein a tool transfer space that is used by the transfer device extends above the workpiece spindle between the working space and the tool magazine. In this way, the transfer device is located in an area of the machine tool that is not needed otherwise. Since a rotary drive and a lifting drive are provided for the tool magazine, desired holding locations of the tool magazine can be provided to the transfer device in the first transfer position.

In an exemplary embodiment, the workpiece spindle is oriented horizontally. In an exemplary embodiment, the tool holder, which is exemplarily arranged as a tool spindle, is oriented above the tool spindle and above a clamped tool, respectively.

In another exemplary embodiment of the machine tool, a counter holder in the form of a secondary workpiece holder is located opposite the workpiece holder, wherein the workpiece holder and the secondary workpiece holder are oriented concentrically with respect to each other, wherein the tool holder and the secondary workpiece holder are spaced apart from the tool magazine at least in a base orientation, and wherein the workpiece holder is adjacent to the tool magazine. The base orientation of the tool holder is, for example, a vertical orientation of the tool holder with the tool clamped, in which the tool holder can perform machining. The base orientation of the secondary workpiece holder is, for example, spaced from the (primary) workpiece holder such that a workpiece can be clamped between the two workpiece holders.

The secondary workpiece holder is designed, for example, as a counter spindle or as a tailstock. The secondary workpiece holder is usually arranged at a greater distance from the tool magazine than the (primary) workpiece holder. In this way, the tool magazine and, for instance, the transfer device can be arranged in an area that is not occupied by the secondary workpiece holder and likewise not occupied by the secondary tool holder.

According to another exemplary embodiment, the machine tool further comprises a secondary tool holder that is movable in at least two axes relative to the frame, wherein the tool holder and the secondary tool holder are oriented opposite each other. For example, both the (primary) tool holder and the secondary tool holder are each oriented vertically in a base orientation. The secondary tool holder may also be arranged as a so-called overhead spindle. In an exemplary embodiment, the (primary) tool holder is arranged above the workpiece and the secondary tool holder is arranged below the workpiece.

In other words, the “first” toolholder can also be referred to as the primary toolholder. The terms “primary” and “secondary” are used merely to distinguish between them and do not necessarily specify a qualitative or quantitative order.

It is to be understood that the previously mentioned features and those mentioned in the following may not only be used in the respectively indicated combination, but also in other combinations or as isolated features without leaving the spirit and scope of the present disclosure.

### BRIEF DESCRIPTION OF THE DRAWINGS

Further features and advantages of the present disclosure will be apparent from the following description and explanation of several exemplary embodiments with reference to the drawings, wherein:

FIG. 1: is a simplified frontal view of a machine tool having a tool changing device;

FIG. 2 is a simplified top view of the arrangement according to FIG. 1, with the enclosure partially removed;

FIG. 3: is a perspective view of the machine tool according to FIGS. 1 and 2, with the housing partially hidden and the tool changing device omitted;

FIG. 4: is a frontal partial view of a machine tool for illustrating a tool change;

FIG. 5: is a perspective view of a tool changing device with tool magazine and transfer device;

FIG. 6: is a perspective view based on FIG. 5 for illustrating degrees of freedom of movement of the tool magazine;

FIG. 7: is a detailed perspective view of a transfer device;

FIG. 8: is a further detailed perspective view based on the view shown in FIG. 7, illustrating the operation of the transfer device;

FIG. 9: is a simplified view of a transfer device cooperating with a tool magazine, from below;

FIG. 10: is a partial perspective view of components of the transfer device and the tool magazine,

FIG. 11: is a further partial view based on the arrangement according to FIG. 10 with modified view orientation;

FIG. 12: is a schematic, sectional partial view based on the arrangement according to FIG. 10;

FIG. 13: is a partial perspective view of a double gripper of the transfer device; and

FIG. 14: is a simplified block diagram illustrating an exemplary embodiment of a method for changing a tool of a machine tool.

### EMBODIMENTS

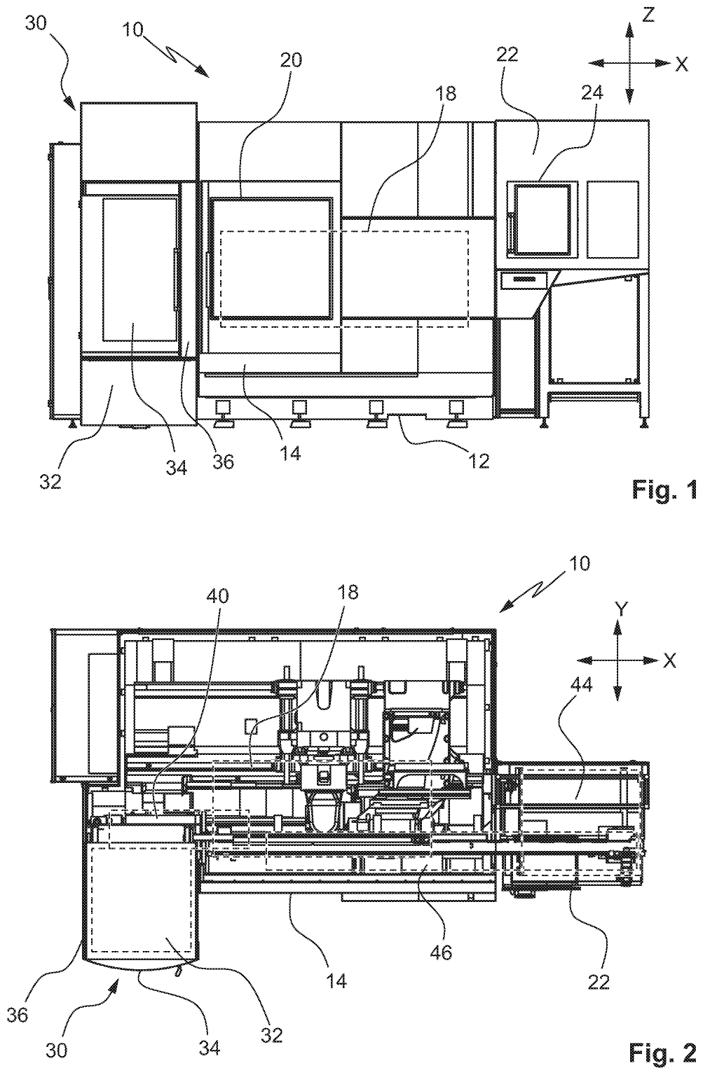

FIG. 1 illustrates, by means of a frontal view, a machine tool that is overall designated by 10. The basic structure of the machine tool 10 shown in FIG. 1 is illustrated with supplementary reference to FIGS. 2-4.

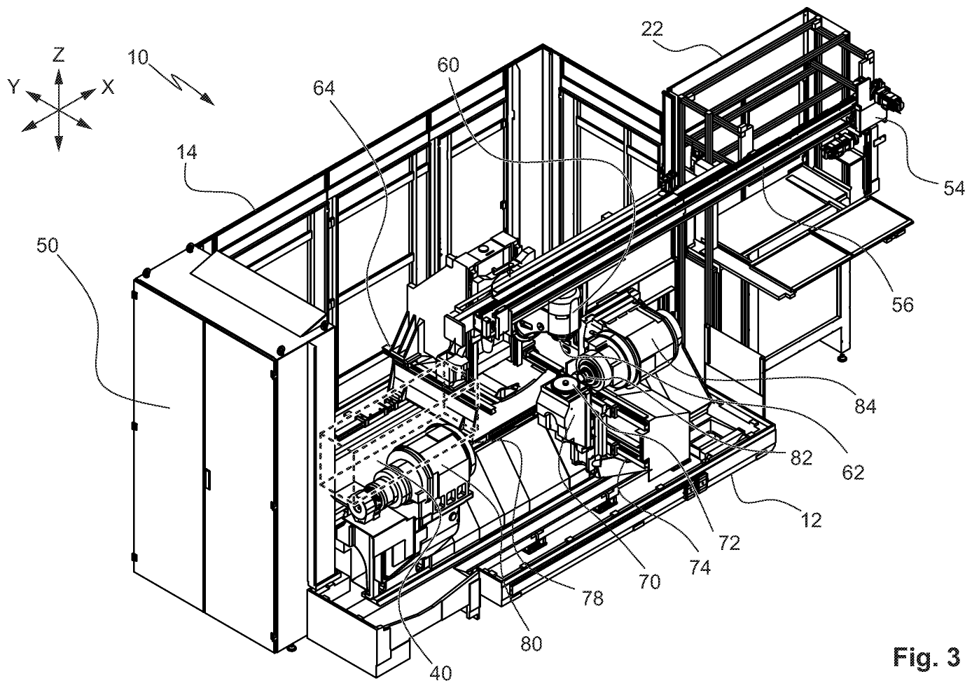

In at least some of the Figures herein, a Cartesian coordinate system X-Y-Z is shown for illustrative purposes. The coordinate system is used for illustrating basic orientations and axes of motion of the machine tool 10 and of components thereof. An axis denoted by X generally indicates a longitudinal extension. An axis denoted by Y (compare FIG. 2 and FIG. 3) generally denotes a depth extension. In the exemplary embodiment, the axes X and Y together define a horizontal plane. An axis denoted by Z generally indicates a height extension. The coordinate system X-Y-Z is used primarily for illustration and is not to be understood in a restrictive manner. It is understood that other coordinate systems may also be used to describe the machine tool 10 and other components. The person skilled in the art can carry out corresponding transformations.

The machine tool 10 includes a frame 12, which may also be referred to as a bed. Furthermore, an enclosure 14 is provided, which surrounds a working space 18 and other components of the machine tool 10 and shields them from an environment at least during machining. The working space 18 is indicated by a dashed block in FIG. 1 and FIG. 2, respectively. The working space 18 is typically the area, in which the machine tool 10 can act on a workpiece (not shown) for machining purposes. Further, in FIG. 1, an access door to the working space 18 is indicated by 20.

In the exemplary embodiment, the machine tool 10 further comprises a so-called workpiece transfer module 22. The workpiece transfer module 22 serves, for example, to remove machined workpieces. In some cases, the workpiece transfer module 22 may also serve to feed unmachined workpieces. In the exemplary embodiment according to FIG. 1, 24 indicates an access door to the workpiece transfer module 22.

The machine tool 10 further comprises a tool changing device 30. The tool changing device 30 comprises a tool magazine 32. In the exemplary embodiment according to FIGS. 1 and 2, the tool magazine 32 is arranged in a housing 36 that is accessible through an access door 34. Accordingly, FIG. 1 shows an exemplary embodiment of the machine tool 10 in frontal view, wherein the working space 18 is accessible through the access door 20, the workpiece transfer module 22 is accessible through the access door 22, and the tool magazine 32 is accessible through the access door 34.

FIG. 2 shows a top view of the machine tool 10 shown in FIG. 1, with the enclosure 14 partially hidden so that components of the machine tool 10 are visible. The working space 18 is indicated by a dashed block. Furthermore, a tool transfer space 40 extends between the tool magazine 32 and the working space 18, which is also indicated by a dashed block. The tool transfer space 40 serves to transfer tools between the tool magazine 32 and a tool holder inside the working space 18. The tool transfer space 40 and the working space 18 overlap one another in the embodiment shown in FIG. 2.

Further, in FIG. 2, a supply area 44 for workpieces is indicated by a dashed block. In the supply area 44, workpieces to be processed or processed workpieces can be provided for further handling operations. A workpiece transfer space 46, also indicated by a dashed block, extends between the workpiece transfer module 22 and the working space 18. In the workpiece transfer space 46, workpieces can be moved between the working space 18 and the supply area 44. In principle, the workpiece transfer module 22 can be used both for loading workpieces and for unloading workpieces. However, it is also conceivable to feed workpieces to be machined in other ways. This can be done, for example, via a bar loader or the like.

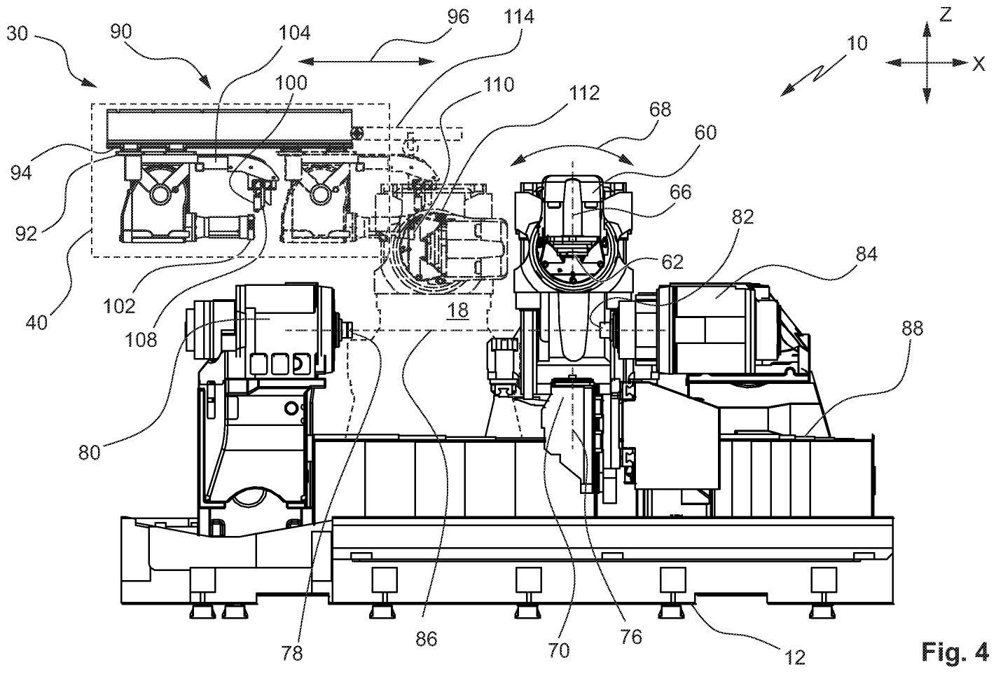

Based on the illustration according to FIG. 1 and FIG. 2, FIG. 3 shows a perspective view of the machine tool 10, wherein the tool changing device 30 with the tool magazine 32 is hidden for illustrative purposes. Furthermore, the enclosure 14 is partially hidden so that internal components of the machine tool 10 are visible. In addition, reference is made to the frontal partial view of the machine tool 10 according to FIG. 4, which in particular shows the working space 18 with components arranged there.

FIG. 3 shows a control unit 50 of the machine tool 10. The control unit 50 is used to control components of the machine tool 10. This includes, if necessary, control of the workpiece transfer module 22 and/or the tool changing device 30.

In the exemplary embodiment according to FIG. 3, the workpiece transfer module 22 is provided with or coupled to a movable loading unit 54 that is arranged at a loading portal 56. The loading portal 56 extends through the workpiece transfer chamber 46, compare FIG. 2. In this way, workpieces can be moved between the working space 18 and the supply area 44 and/or the workpiece transfer module 22.

A tool spindle 60, which carries a tool holder 62, is provided in the working space 18 of the machine tool 10. The tool spindle 60 may also be referred to as the primary tool spindle. The tool holder 62 may also be referred to as the primary tool holder. The tool holder 62 is used to hold a tool. A kinematic system 64 is provided for the tool spindle 60, which in the exemplary embodiment provides linear movement of the tool spindle 60 in three axes (X, Y, Z). Furthermore, the kinematic system 64 can enable a swiveling movement of the tool spindle 60, for example around the Y-axis (so-called B-axis). In FIG. 4, a curved double arrow illustrates such a swivel drive 68. The workpiece spindle 60 is configured for rotationally driving a tool arranged in the tool holder 62 about a longitudinal axis 66.

FIGS. 3 and 4 further illustrate an exemplary embodiment, in which an additional tool spindle 70 with a tool holder 72 is provided in addition to the tool spindle 60. The tool spindle 70 may also be referred to as a secondary tool spindle or an overhead spindle. The tool holder 72 may also be referred to as a secondary tool holder. In the exemplary embodiment, a kinematic system 74 is provided for the tool spindle 70, for example, to allow translational (linear) motion in two axes (X, Y) or, optionally, in three axes (X, Y, Z). The tool spindle 70 can rotationally drive the tool holder 72 and a tool disposed therein about a longitudinal axis 76.

The machine tool 10 further includes a workpiece holder 78 that is associated with a workpiece spindle 80. The workpiece spindle 80 may also be referred to as the main spindle or primary workpiece spindle. The workpiece holder 78 may also be referred to as the primary workpiece holder 78. The workpiece holder 78 is used to hold a workpiece. The workpiece is, for example, bar-shaped or shaped as a chuck part. The workpiece may be at least partially rotationally symmetrical in shape, but this is not a mandatory requirement. The workpiece spindle 80 can drive the workpiece about a longitudinal axis 86, compare FIG. 4. In the exemplary embodiment, the workpiece spindle 80 is fixedly arranged on the frame 12.

Opposite the workpiece spindle 80, a workpiece spindle 84 provided with a workpiece holder 82 is provided on the frame 12. In the exemplary embodiment, the workpiece spindle 84 is movable relative to the frame in the X direction, compare a kinematic system indicated by 88 in FIG. 4. In this way, the distance between the workpiece spindle 80 and the workpiece spindle 84 can be varied. The workpiece spindle 84 can also be referred to as a counter spindle or secondary workpiece spindle. The workpiece holder 82 may also be referred to as a secondary workpiece holder. In the exemplary embodiment, the workpiece holders 78, 82 are oriented concentrically with respect to each other. The workpiece holders 78, 82 can jointly hold and clamp a workpiece. However, in principle, it is also conceivable that each of the two workpiece holders 78, 82 holds and clamps a separate workpiece. Accordingly, it is conceivable that the workpiece spindle 84 is also provided with a drive for rotationally driving a workpiece about the longitudinal axis 86.

FIG. 3 illustrates a conceivable position for the tool transfer area 40 by means of a cuboid of dashed lines that is drawn in perspective, see also FIG. 2. The tool transfer area 40 can therefore be arranged above the workpiece spindle 80. This area is available for a tool transfer between working space 18 and tool magazine 32.

FIG. 4 illustrates a transfer device 90 that is arranged at least partially in the tool transfer chamber 40, which together with the tool magazine 32 forms a component of the tool changing device 30.

In the exemplary embodiment, the transfer device 90 includes a transfer carriage 92 that is movable on a guide 94. In the exemplary embodiment, the guide 94 is a horizontal guide. The guide 94 extends in the tool transfer space 40, compare FIG. 2 and FIG. 3. A transfer movement is illustrated by a transfer axis 96. In the exemplary embodiment, the transfer axis 96 is oriented parallel to the X-axis.

The transfer carriage 92 carries a transfer receptacle 100 that is mounted on an extension arm 104. Furthermore, the transfer carriage 92 carries a double gripper 102 that is facing the transfer receptacle 100. In FIG. 4, the transfer carriage 92 is shown in a first transfer position 108. A dashed representation illustrates a second transfer position 110. The transfer carriage 92 is movable along the transfer axis 96 between the first transfer position 108 and the second transfer position 110. In this way, tools can be exchanged between the tool magazine 32 and the working space 18.

In the second transfer position 110, the transfer carriage 92 extends at least partially into the working space 18 in order to transfer a tool to the tool holder 62 of the tool spindle 60 there. Using the kinematic system 64 and the swivel drive 68, the tool spindle 60 can be moved with the tool holder 62 towards a change position 112 (indicated in FIG. 4 by a dashed representation). In the change position 112, the tool holder 62 is oriented such that the longitudinal axis 66 is oriented parallel to the transfer axis 96. In this way, a tool can be easily changed between the transfer carriage 92 and the tool holder 62 of the tool spindle 60 in the second transfer position 110.

Further, in FIG. 4, a door for the working space 18 that is designated by 114 is indicated by means of a dashed illustration. In the exemplary embodiment, the door 114 is pivotable. The door 114 is actuated by the transfer carriage 92 during movement of the transfer carriage 92 from the first transfer position 108 to the second transfer position 110. When the transfer carriage 92 is fully retracted from the working space 18, the door 114 can close automatically.

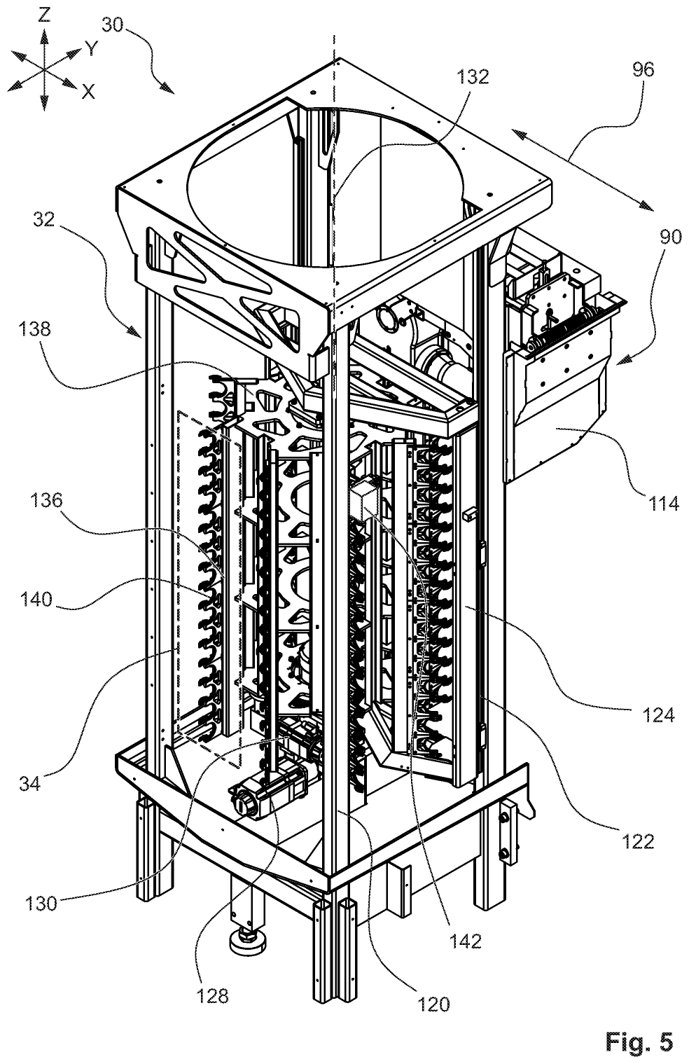

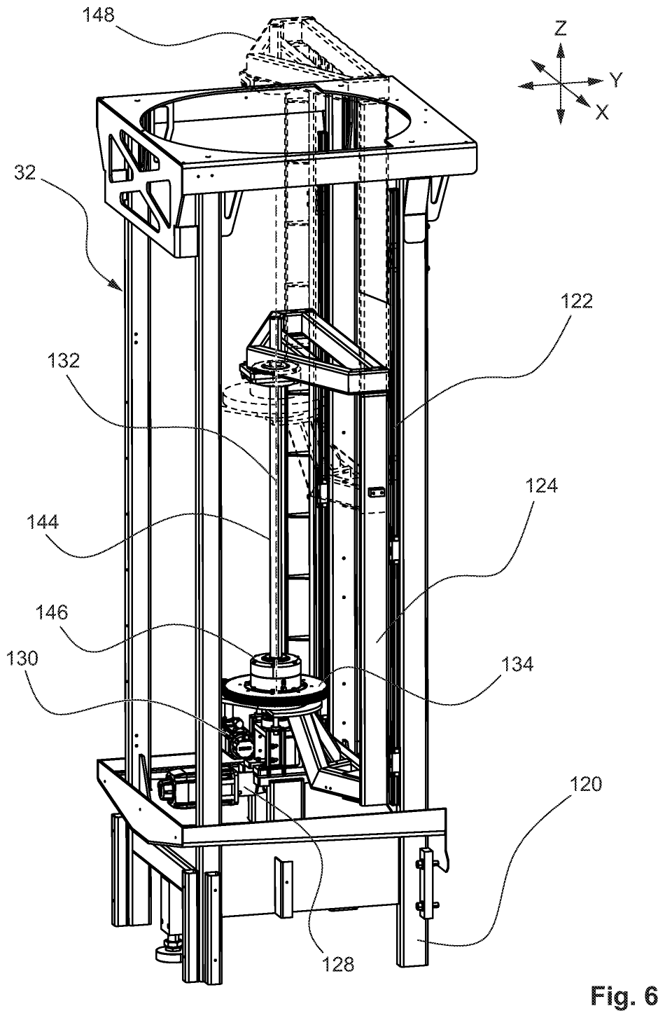

With reference to FIGS. 5 and 6, an exemplary embodiment of a tool magazine 32 of the tool changing device 30 is illustrated. The tool magazine 32 is approximately tower-like or column-like in design. In FIG. 5, a conceivable position of an access door 34 is indicated with 34 by means of a dashed block. A housing 36, which is for instance shown in FIG. 2, is hidden in FIGS. 5 and 6.

The tool magazine 32 rests on a frame 120. The frame 120 may be a component of the frame 12 of the machine tool. However, the frame 120 may also be a separate magazine frame. In the exemplary embodiment, the frame 120 has a tower-like design. On the frame 120, in the exemplary embodiment, the tool changing device 90 is arranged, for instance fixed to the frame. In other words, the frame 120 carries the guide 94 (compare FIG. 4) for the transfer carriage 92. FIG. 5 further shows the door 114, which is actuated by the transfer carriage 92 during a movement of the transfer carriage 92 along the transfer axis 96.

A vertical guide 122 is arranged on the frame 120 in the exemplary embodiment. The tool magazine 32 sits on a bracket 124, which is vertically movable along the guide 122 (parallel to the Z direction). A linear drive 128 is provided for this movement, which may be referred to as a lifting drive. The movement of the tool magazine 30 takes place along a magazine axis 132, compare FIG. 5 and FIG. 6.

In addition to the linear drive 128, a rotary drive 130 is provided that is configured to rotate the tool magazine 32 about the magazine axis 132. In the exemplary embodiment, the tool magazine 32 comprises a plurality of segments 136 that are distributed around the magazine axis 132. The segments 136 are attached to support disks 138 that are offset from each other along the magazine axis 132. In the exemplary embodiment, the segments 136 are configured similar to the blades of a paddle wheel. The segments 136 each support a plurality of holding locations 140. The holding locations 140 are used to receive tools. The holding locations 140 are arranged along the magazine axis 132 as well as distributed around the magazine axis 132. In this manner, the tool magazine 32 can provide a plurality of holding locations 140 for receiving tools.

Together, the linear drive 128 and the rotary drive 130 can move the tool magazine 32 to provide a desired holding location 140 for a tool at the first transfer position 108 (compare FIG. 4) so that the tool can be removed and transferred by the transfer device 90. Similarly, an empty holding location 140 can be provided at the first transfer position 108 for a tool to be deposited there by the transfer device 90.

In addition, the tool magazine 32 can be controlled by the linear drive 128 and the rotary drive 130 to position one or more holding locations 140 in the area of the access door 34. In this manner, a set-up operation is enabled from the outside. When a plurality of holding locations 140 are loaded, this may be referred to as a block setup.

FIG. 6 shows that the linear drive 128 is coupled to a spindle 144 to rotationally drive the spindle 144. In the embodiment, the spindle 144 sits in the center of the tool magazine 32. A base 146 sits on the spindle 144 and supports the tool magazine 32 and/or its bracket 124. When the spindle 144 is driven by the linear drive 128, the base 146 travels along the spindle 144. In this manner, the bracket 124 can travel with the tool magazine 32 along the magazine axis 132 (parallel to the Z axis). Compare also the dashed illustration in FIG. 6, which illustrates a raised state 148 of the bracket 124 and the tool magazine 32, respectively. Thus, in the exemplary embodiment, the tool magazine 32 may partially extend from an upper opening of the frame 120 in a lifted state.

The illustration according to FIG. 6 further shows that the rotary drive 130 is coupled to a wheel 134. The rotary drive 130 carries, for example, a pinion gear meshing with the wheel 134. In this way, the tool magazine 32 can be rotated about the magazine axis 132.

Based on the embodiment according to FIGS. 4-6, FIGS. 7-9 illustrate a conceivable detailed design of the transfer device 90 and, overall, a tool change between the magazine 32 and the working space 18 of the machine tool 10, in which the tool is transferred by the transfer device 90 to a tool holder (compare tool holder 62 according to FIG. 4).

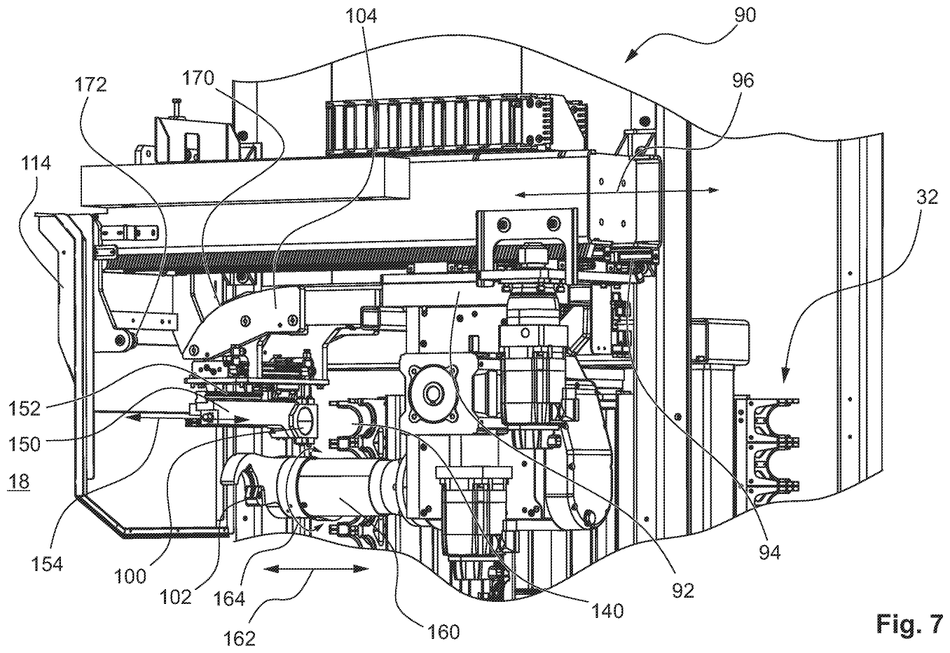

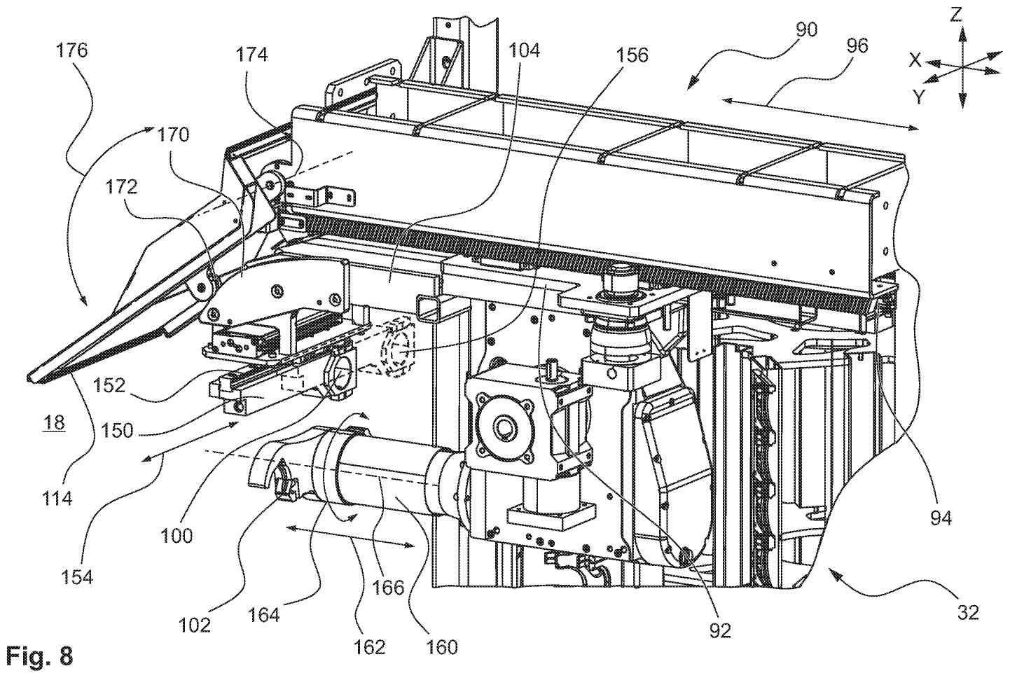

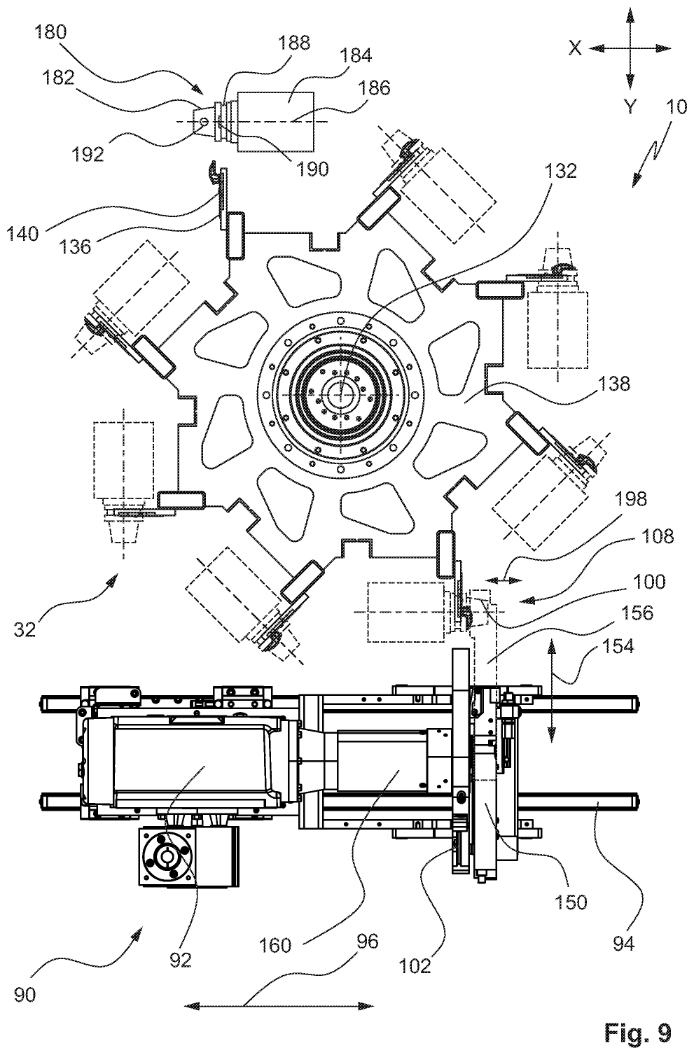

FIGS. 7 and 8 are perspective views of the transfer device 90, compare the arrangement of the transfer device 90 in relation to the tool magazine 32 in FIG. 5. FIG. 9 illustrates the interaction between the transfer device 90 and the tool magazine 32 using a view from below. For orientation, also compare the coordinate systems X-Y-Z in FIGS. 7-9.

The transfer carriage 92 of the transfer device 90 is mounted on a guide 94 for movement along the transfer axis 96. The transfer carriage 92 includes an arm 104 that supports a transfer receptacle 100. Furthermore, a double gripper 102 is mounted on the transfer carriage 92. Tools are transferred between the transfer device 90 and the tool magazine 32 using the transfer receptacle 100, see also FIG. 9. In FIG. 9, tools are designated by 180.

The transfer receptacle 100 is part of an offset slide 150, which is movable along an offset axis 154 via an offset rail 152. In the embodiment, the arm 104 of the transfer carriage 92 carries the offset slide 150. The offset slide 150 with the transfer receptacle 100 is movable along the offset axis 154 between a retracted position and an extended position (compare the dashed illustration labeled 156 in FIG. 8). In the extended position of the offset slide 150, the transfer receptacle 100 is aligned with respect to a holding location 140 that is provided at the first transfer position 108 such that a tool 180 can be transferred between the holding location 140 and the transfer receptacle 100, compare FIG. 9. Thus, this includes a concentric alignment between the transfer receptacle 100 and the holding location 140, for instance.

Further, in the FIGS. 7 and 8, a stroke axis is indicated by a double arrow designated by 162, which is assigned to the double gripper 102 in the exemplary embodiment. The double gripper 102 is mounted on the transfer carriage 92 via a linear guide 160, so that a translatory movement of the double gripper 102 along the stroke axis 162 is possible. In this way, a distance between the double gripper 102 and the transfer receptacle 100 of the offset slide 150 can be varied along the transfer axis 96. This enables a transfer of tools 180 between the transfer receptacle 100 and the double gripper 102. Tools 180 can be removed from or inserted into the transfer receptacle 100 by the double gripper 102 along the stroke axis 162.

FIGS. 7 and 8 further illustrate a pivot drive of the double gripper 102 by means of a curved double arrow designated by 164. In this way, the double gripper 102 can be rotated about its pivot axis 166 by the pivot drive 164. This allows, for example, immediate replacement of a previously used tool 180 with a new tool 180 at the tool holder 62 in the second transfer position 110 (compare FIG. 4).

The arm 104 of the transfer carriage 92 further supports a sliding piece designated by 170. The sliding piece 170 is configured to act on the door 114 to open the door 114 when the transfer carriage 92 is moved between the first transfer position 108 and the second transfer position 110. FIG. 7 shows a closed state of the door 114. FIG. 8 shows a partially opened state of the door 114.

For example, the door 114 is configured as a flap that is pivotable about an axis 174. In the exemplary embodiment, the door 114 carries one or two rollers 172 that can be contacted by corresponding sliding pieces 170 at an end of the arm 104 that is facing the working space 18. In this manner, the door 114 can be actuated by the carriage 92 with little wear. When the slide 92 enters the working space 18, the door 114 is automatically opened. In FIG. 8, a curved double arrow designated by 176 illustrates the movement of the door 114 about the axis 174.

FIG. 9 illustrates a change of tools 180 between the tool magazine 32 and the transfer device 90. The tool magazine 32 comprises a plurality of segments 136 that are distributed around the magazine axis 132. In the exemplary embodiment, the segments 136 are attached to support disks 138. The segments 136 carry holding locations 140 for the tools 180.

The tools 180 include, for example, a support shaft 182 that is primarily configured to mount the tool 180 at a tool holder 62 of a tool spindle 60 (compare FIG. 4). Further, a machining section 184 is provided, for example comprising a cutting contour. In the case of a rotationally driven tool 180, a longitudinal axis 186 is further provided. The longitudinal axis 186 is further the center axis of the support shaft 182.

The tool 180 further includes a receiving groove 188 adjacent the support shaft 182. The receiving groove 188 may also be referred to as a gripper groove. For example, the receiving groove 188 is configured as a circumferential groove. In the exemplary embodiment according to FIG. 9, the tool 180 further comprises at least one detent recess 190 at the receiving groove 188 for positive positional securing. Similarly, at least one detent recess 192 for positive positional securing is also provided at the support shaft 182.

The tools 180 are each seated with their receiving groove 188 in the holding locations 140 of the tool magazine 32. Therefore, the receiving groove 188 is not available for handling purposes. For this reason, the transfer receptacle 100 of the offset slide 150 has a quiver-like design and is adapted to the support shaft 182. In other words, the transfer receptacle 100 is, for example, conically shaped. Thus, the offset slide 150 with the transfer receptacle 100 can be put over or detached from the support shaft 182 of a tool 180 that is positioned in the first transfer position 108, using the movement of the transfer carriage 92 along the transfer axis 96. This is illustrated in FIG. 9 by an insertion stroke designated by 198.

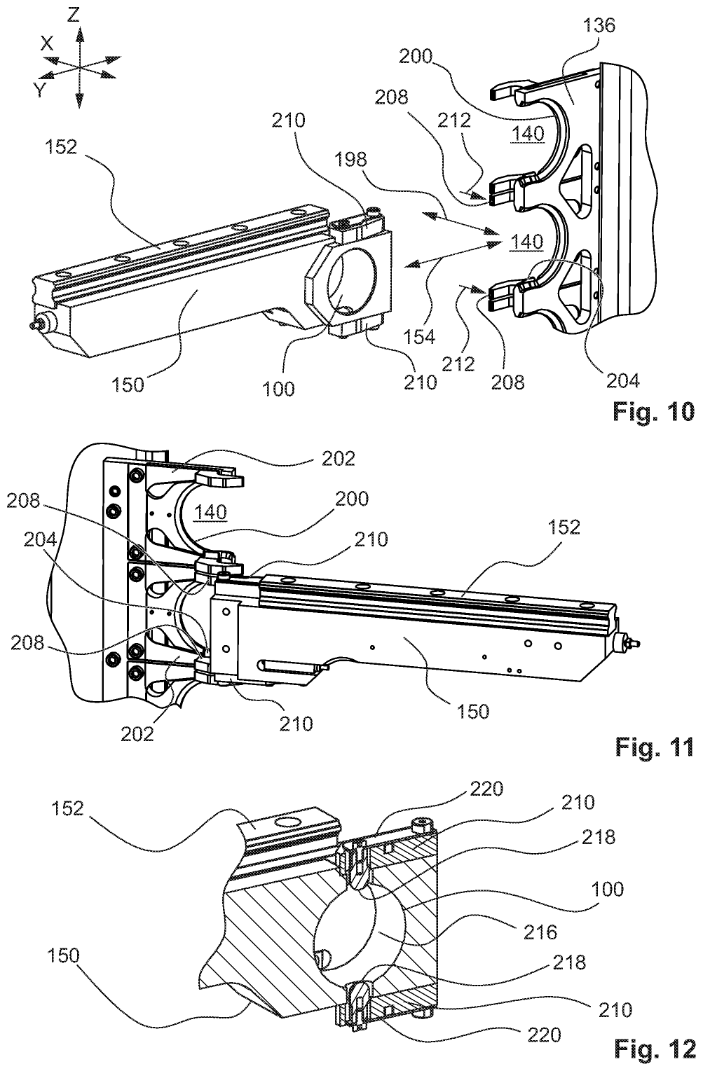

Thus, depositing or removing a tool 180 comprises not only a movement of the offset slide 150 along the offset axis 154, but also a movement of the transfer carriage 92 as a whole along the transfer axis 96, compare the insertion stroke 198. Tools 180 can be moved laterally out of the holding locations 140 or inserted into the holding locations 140, compare the movement along the offset axis 154. In the exemplary embodiment, coupling of the support shaft 182 with the transfer receptacle 100 is only possible via a movement orthogonal thereto, compare the insertion stroke 198. The combined movement along the offset axis 154 and through the insertion stroke 198 is additionally indicated in FIG. 10 by double arrows.

FIGS. 10, 11 and 12 detail the exchange of tools 180 between the tool magazine 32 and the transfer receptacle 100 of the offset slide 150, as well as the seating of the tool 180 in the tool magazine 32 and in the transfer receptacle 100.

It can be seen from FIGS. 10 and 11 altogether, due to their different view orientation, that the holding locations 140 for the tools 180 are each formed in a recess 200 in one of the segments 136. In the exemplary embodiment, a retaining spring 202 is assigned to each of the holding locations 140, compare also FIG. 11. The retaining springs 202 serve to secure the position of the tools 180 in the holding location 140 in a force-fitting and/or form-fitting manner. The retaining springs 202 each carry at least one locking element 204, which is designed, for example, to contact the latching recess 190 in the receiving groove 188 of the tool 180, compare also FIG. 9. When a locking element 204 engages in a latching recess 190 of a receiving groove 188, the tool 180 is positively secured in the holding location 140. In the exemplary embodiment, the tool 180 can then no longer be removed laterally (compare the offset axis 154).

Therefore, it is necessary to displace the retaining spring 202 with the at least one locking element 204 in order to be able to deposit the tool 180 in the holding location 140 and/or to be able to remove the tool 180 from the holding location 140. For this purpose, the retaining springs 202 carry so-called contact pieces 208, which are designed to be contacted by displacement pieces 210 that are arranged on the offset slide 150. The displacement pieces 210 and the contact pieces 208 have inclined flanks, so that a desired deflection of the retaining spring 202 with the locking element 204 transversely or obliquely to the offset axis 154 is also possible when the offset slide 150 is moved along the offset axis 154. This can be used to insert a tool 180 disposed in the transfer receptacle 100 into a holding location 140.

To remove a tool 180 from a holding location 140, there is first a movement of the offset slide 150 with the transfer receptacle 100 along the transfer receptacle 96 (compare the insertion stroke 198). This movement also allows the displacement pieces 210 to contact the contact pieces 208 and, as a result, deflect the retaining spring 202 with the at least one locking element 204. Thereafter, the tool 180 is unlocked, and the tool 180 can be removed laterally (compare offset axis 154) from the holding location 140. In FIG. 10, arrows indicated by 212 illustrate the force on the contact pieces 208 applied by the displacement pieces 210 to displace the locking elements 204 of the retaining springs 202 in the desired manner.

FIG. 12 illustrates a partial cross-sectional view of the offset slide 150. For instance, the transfer receptacle 100 is shown. The transfer receptacle 100 is shaped approximately like a quiver. The transfer receptacle 100 provides a receiving seat 216 for a support shaft 182 of a tool 180. For securing the position, at least one locking element 218 is associated with the transfer receptacle 100, which is configured, for example, as a ball or ball section. The at least one locking element 218 can engage, for example, in a detent recess 192 on the support shaft 182 of the tool 180, compare also FIG. 9. In the exemplary embodiment according to FIG. 12, two opposing locking elements 218 are provided, each of which is arranged on a deflectable spring 220. This results in a holding force that secures a received tool 180 in the receiving seat 216 of the transfer receptacle 100 positively and force-fitted.

To remove a tool 180, this holding force must be overcome. This can be accomplished by the double gripper 102 gripping the tool 180 at its receiving groove 188 and pulling it out of the transfer receptacle 100 due to a movement of the double gripper 102 along the stroke axis 162 (compare FIG. 7 and FIG. 8).

In the embodiment shown in FIG. 12, the spring 220 for the locking element 218 is arranged on each of the displacement pieces 210. The locking element 218 is seated in a recess in the displacement piece 210. The locking element 218 protrudes into the receiving seat 216 of the transfer receptacle 100. Deformation of the spring 220 allows the locking element 218 to disengage, allowing the support shaft 182 of a tool 180 to pass.

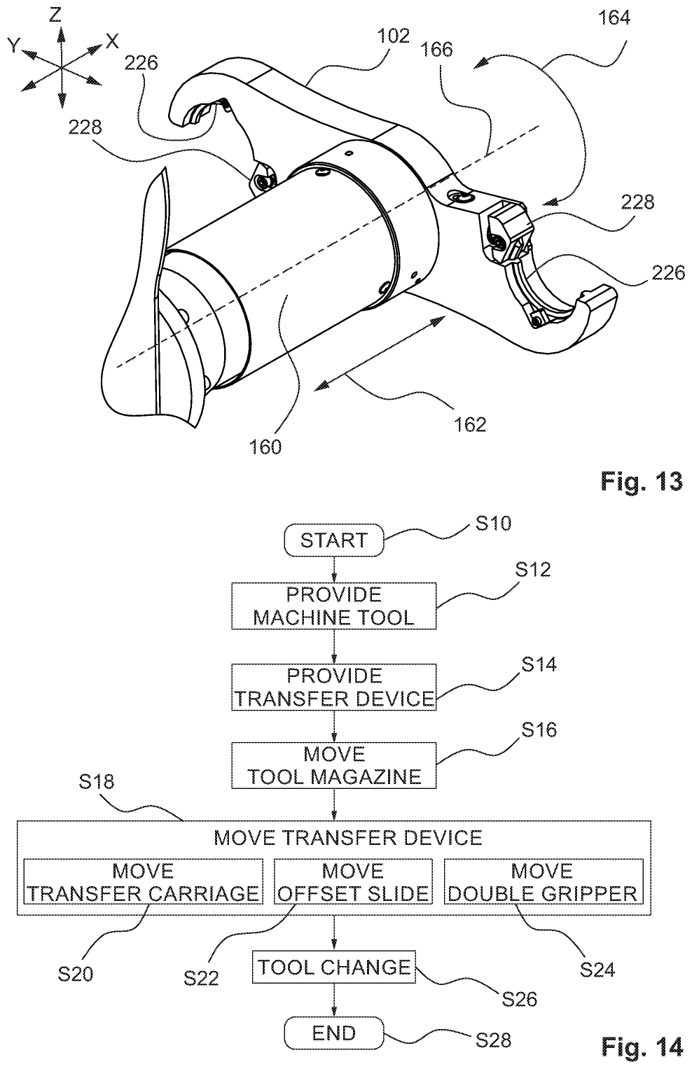

In addition to the detailed embodiments hereinbefore, FIG. 13 illustrates a possible embodiment of the double gripper 102. The double gripper 102 can be pivoted about a pivot axis 166 by a pivot drive (compare the curved double arrow 164). In this manner, for example, by pivoting 180°, one tool 180 can be removed and replaced by another tool 180. However, this usually also includes a movement along the stroke axis 162 that is oriented parallel to the swivel axis 166.

The double gripper 102 provides two seats 126 for tools 180. In the exemplary embodiment according to FIG. 13, an additional locking element 228 is respectively provided to positively secure the seat of the tool 180 on the double gripper 102. On the one hand, the locking elements 228 can be arranged as resilient locking elements. Accordingly, the seat of the tools 180 on the double gripper 102 can be released by a certain force. However, it is also conceivable to selectively actuate the locking elements 228 to release or secure the positive position of the tools 180 on the double gripper 102 as required.

FIG. 13 further illustrates the linear guide 160, which is configured as an arm for the double gripper 102, for instance. In the exemplary embodiment, the double gripper 102 is movable along the linear guide 160, compare the stroke axis indicated by a double arrow 162. This allows the double gripper 102 to be moved relative to the transfer receptacle 100 along the transfer axis 96, compare also FIG. 9. This allows tools 180 to be removed from the transfer receptacle 100 or tools 180 to be deposited in the transfer receptacle 100.

FIG. 14 uses a schematic block diagram to illustrate an exemplary embodiment of a method for changing a tool in a machine tool. In the exemplary embodiment, the method starts at a step S10.

A step S12 relates to the provision of a tool magazine, for instance a tool magazine, which is rotatable about an axis of rotation and translatable along a linear axis by a linear drive, for instance in a vertical direction. In an exemplary embodiment, the linear drive occupies an installation space in the center of the tool magazine. For example, the tool magazine has a columnar or tower-like design. Since the linear axis is at least partially integrated into the tool magazine, the tool magazine occupies a small overall footprint, although the tool magazine itself can be moved in several degrees of freedom. One advantage of this design is that any number of holding locations for receiving tools can be provided in a first transfer position. This reduces the need for additional handling equipment.

A step S14 concerns the provision of a transfer device, in particular a transfer device, which is designed to exchange tools directly with the tool magazine in the first transfer position and to exchange tools directly with a tool holder of the machine tool in a second transfer position. By way of example, the transfer device comprises a transfer carriage, which is movable along a transfer axis, and which comprises an offset slide, which is movable along an offset axis, and a double gripper, which can be pivoted about a pivot axis.

A step S16 refers to a movement of the tool magazine in order to provide a tool or an empty holding location in the first transfer position. For this purpose, the tool magazine can be rotated by the rotary drive and moved along the linear axis by the linear drive. In this way, holding locations that are distributed around the circumference of the tool magazine can be provided. The tool magazine is not only rotated, but also moved linearly as a whole in order to be able to approach any holding location.

A step S18 refers to a movement of the transfer device, which also comprises a coordinated movement of components of the transfer device. In the exemplary embodiment, step S18 comprises substeps S20, S22, S24, which can be performed at least partially in parallel.

Substep S20 refers to a movement of the transfer carriage along the transfer axis. This movement can also be referred to as a global movement of the transfer carriage between the first transfer position and the second transfer position. The movement of the transfer carriage along the transfer axis can also be used to actuate a door to the working space of the machine tool. The transfer axis is inclined with respect to the linear axis of the tool magazine, for instance oriented orthogonally thereto.

Substep S22 relates to a movement of an offset slide along an offset axis. The offset slide comprises a transfer receptacle, which is, for example, of quiver-like design and is adapted to a support shaft of the tool. The offset axis is inclined relative to the transfer axis, for instance oriented orthogonally to the transfer axis. In this way, the offset slide can be extracted laterally in order to be moved into the desired orientation with respect to the provided holding location for pickup or transfer of a tool. By coordinating with substep S20, an insertion stroke can be provided so that the support shaft of the tool can engage with or move out of the transfer receptacle.

Substep S24 comprises a movement of the double gripper. This comprises, for example, a swiveling movement about a swiveling axis that is oriented parallel to the transfer axis. The double gripper is configured to remove tools from the transfer receptacle of the offset slide or to insert them into the transfer receptacle. For this purpose, an additional stroke axis is provided, for example, which moves the double gripper relative to the transfer receptacle along the transfer axis. Furthermore, the double gripper can provide tools in a suitable orientation for exchange with a tool holder of the machine tool in the second transfer position.

In a further step S26, a tool change between the transfer device and the tool holder is performed by the double gripper in the second transfer position. In this way, for example, a tool can be removed from a tool holder of the machine tool and exchanged for a new tool.

In the exemplary embodiment, the method ends at a step S28. It is understood that the method is also applicable, at least in sections, to the replacement of a tool from a tool holder in the working space of a machine tool. Accordingly, some of the method steps can be performed backwards to deposit the tool in the tool magazine.

What is claimed is:

1. A tool changing device for a machine tool, comprising:
a tool magazine comprising:
a magazine axis, wherein the tool magazine is rotatable about the magazine axis by a rotary drive, and
a plurality of holding locations for tools that have a support shaft and a receiving groove,
wherein at least some of the holding locations are arranged offset relative to one another along the magazine axis,
wherein at least some of the holding locations are arranged offset relative to one another about the magazine axis, and
wherein the holding locations are configured to hold the tools at the receiving groove,
a transfer device comprising a transfer carriage,
wherein the transfer device is movable between a first transfer position in relation to the tool magazine and a second transfer position to transfer tools between the tool magazine and a tool holder of the machine tool, and
a linear drive for the tool magazine that is configured to move the tool magazine along the magazine axis relative to the transfer device to provide, together with the rotary drive, a selected holding location in the first transfer position.

2. The tool changing device of claim 1,
wherein the transfer device is movable along a transfer axis between the first transfer position and the second transfer position,
wherein the transfer axis is oriented perpendicular to the magazine axis, and
wherein the transfer axis comprises a frame-fixed guide, along which the transfer carriage of the transfer device is movable.

3. The tool changing device of claim 1,
wherein the first transfer position is fixed with respect to a frame.

4. The tool changing device of claim 1,
wherein the transfer device directly transfers the tools to and from the holding locations of the tool magazine.

5. The tool changing device of claim 1,
wherein the tool magazine comprises two or more segments that are distributed about the magazine axis, and
wherein the segments have holding locations that are arranges in series and offset from one another along the magazine axis.

6. The tool changing device of claim 5,
wherein the holding locations are formed at the segments, and
wherein the holding locations have outwardly open recesses that are adapted to the receiving grooves of the tools.

7. The tool changing device of claim 1,
wherein the transfer device comprises a transfer receptacle, and
wherein the transfer receptacle is configured to embrace the support shaft of the tools.

8. The tool changing device of claim 7,
wherein an offset axis having an offset slide is provided at the transfer carriage of the transfer device, and
wherein the offset axis moves the transfer receptacle between a retracted position and an extended position.

9. The tool changing device of claim 7,
wherein the transfer receptacle comprises resilient locking elements to secure a received tool.

10. The tool changing device of claim 8,
wherein at least some of the holding locations of the tool magazine are coupled to a retaining spring that secures the received tool with a locking element in the holding location,
wherein the transfer receptacle is formed at the offset slide, and
wherein the offset slide is configured to deflect the retaining spring in order to deposit a tool in the holding location or to release it from the holding location.

11. The tool changing device of claim 7,
wherein the transfer device comprises a double gripper that is arranged at the transfer carriage, and
wherein the double gripper is pivotable about a pivot axis.

12. The tool changing device of claim 11,
wherein the transfer device comprises a stroke axis arranged at the transfer carriage, and
wherein the stroke axis is coupled with at least one of the double gripper and the transfer receptacle, and configured to transfer the tools between the double gripper and the transfer receptacle.

13. The tool changing device of claim 12,
wherein the stroke axis is coupled to the double gripper and arranged between the double gripper and the transfer carriage, and
wherein the stroke axis coincides with the pivot axis of the double gripper.

14. The tool changing device of claim 1,
wherein, upon the travel movement of the transfer carriage between the first transfer position and the second transfer position, the transfer carriage actuates a door that closes a working space of the machine tool, and
wherein the transfer carriage projects at least temporarily into the working space.

15. The tool changing device of claim 1,
wherein the tool magazine comprises a scanner for tool identification,
wherein the scanner is arranged in a fixed position, and
wherein the tool magazine is configured to be moved along the magazine axis and rotated about the magazine axis to bring a selected holding location into a detection range of the scanner.

16. The tool changing device of claim 1,
wherein the tool magazine has an access door, through which a selected plurality of holding locations that are offset along the magazine axis to each other are accessible from the outside, and
wherein the tool magazine is configured to be moved along the magazine axis and rotated about the magazine axis to position the selected plurality of holding locations at the access door.

17. A machine tool, comprising:
a frame,
at least one workpiece holder for receiving a workpiece,
at least one tool holder for receiving a tool, and
a tool changing device, comprising:
a tool magazine comprising:
a magazine axis, wherein the tool magazine is rotatable about the magazine axis by a rotary drive, and
a plurality of holding locations for tools that have a support shaft and a receiving groove,
wherein at least some of the holding locations are arranged offset relative to one another along the magazine axis,
wherein at least some of the holding locations are arranged offset relative to one another about the magazine axis, and
wherein the holding locations are configured to hold the tools at the receiving groove,
a transfer device comprising a transfer carriage,
wherein the transfer device is movable between a first transfer position in relation to the tool magazine and a second transfer position in relation to a tool holder of the machine tool to transfer tools between the tool magazine and the tool holder, and
a linear drive for the tool magazine that is configured to move the tool magazine along the magazine axis relative to the transfer device to provide, together with the rotary drive, a selected holding location in the first transfer position,
wherein the tool holder is movable relative to the frame to the second transfer position for a tool change.

18. The machine tool of claim 17,
wherein the tool holder is pivotable to bring the tool holder in the second transfer position into a transfer orientation for tool change, and
wherein the transfer orientation of the tool holder involves an orientation parallel to a transfer axis of the transfer device.

19. The machine tool of claim 17,
wherein the tool holder is formed at a pivotable tool spindle and configured to receive the support shaft of the tool, and
wherein the support shaft of the received tool is concentrically placed in the tool holder.

20. The machine tool of claim 18,
wherein the workpiece holder is formed at a workpiece spindle, which is arranged to rotate workpieces about an axis that is in oriented parallel to the transfer axis, and
wherein the tool holder is movable in three or more axes relative to the workpiece holder.

21. The machine tool of claim 20, further comprising:
a counter holder that is configured as a secondary workpiece holder and located opposite the workpiece holder that is configured as a primary workpiece holder,
wherein primary workpiece holder and the secondary workpiece holder are oriented concentrically with respect to each other,
wherein the tool holder and the secondary workpiece holder are spaced away from the tool magazine, at least in a base orientation, and
wherein the primary workpiece holder is adjacent to the tool magazine.

22. The machine tool of claim 17, further comprising:
a secondary tool holder that is movable in at least two axes relative to the frame,
wherein the tool holder is configured as a primary tool holder, and
wherein the primary tool holder and the secondary tool holder are oriented opposite each other.

23. A method of changing a tool at a machine tool, comprising the following steps:
providing a tool magazine having a magazine axis that is rotatable by a rotary drive about the magazine axis and movable by a linear drive along the magazine axis,
wherein the tool magazine has a plurality of holding locations for tools that have a support shaft and a receiving groove,
wherein at least some of the holding locations are arranged offset relative to one another along the magazine axis,
wherein at least some of the holding locations are arranged offset relative to one another about the magazine axis, and
wherein the holding locations are configured to hold the tools at the receiving groove,
providing a transfer device comprising a transfer carriage,
wherein the transfer device is movable between a first transfer position in relation to the tool magazine and a second transfer position to transfer tools between the tool magazine and a tool holder of the machine tool,
moving the tool magazine by the linear drive and the rotary drive to provide a selected holding location for a tool in the first transfer position, and
transferring a tool between the first transfer position and the second transfer position,
wherein in the first transfer position, the tool is directly transferred between the tool magazine and the transfer device, and
wherein in the second transfer position, the tool is transferred between the transfer device and the tool holder.

24. The method of claim 23,
wherein in the second transfer position, the tool is directly transferred between the transfer device and the tool holder of the machine tool.
